(19) United States
(12) Patent Application Publication
(10) Pub. No.: US 2025/0056388 A1
(43) Pub. Date: Feb. 13, 2025

(54) EXTENDED NETWORK SCANNING FOR USER EQUIPMENT WITH MULTIPLE SUBSCRIBER IDENTITY MODULES

(71) Applicant: GOOGLE LLC, Mountain View, CA (US)

(72) Inventors: Edison Chen, Taipei (TW); Grace I. Chen, Cupertino, CA (US)

(21) Appl. No.: 18/720,495

(22) PCT Filed: Dec. 16, 2022
(86) PCT No.: PCT/US2022/053103

§ 371 Date: Jun. 14, 2024

Related U.S. Application Data
(60) Provisional application No. 63/291,524, filed on Dec. 20, 2021.

(51) Int. Cl. H04W 48/16; H04W 88/06

(52) U.S. Cl. CPC H04W 48/16; H04W 88/06

(57) ABSTRACT

A user equipment (UE) having multiple Subscriber Identity Modules (SIMs) scans for network connections using each of the multiple SIMs in sequence, until either a network connection is found, or the UE determines that there is no available network connection. Each of the multiple SIMs supports connection to a different network. In response to a primary SIM of the UE identifying an out-of-service (OOS) condition for the corresponding network, the UE sequentially employs a different one of the multiple SIMs to attempt to connect to a different network. This increases the likelihood that the UE is able to connect to a network, thereby improving the overall user experience.

### BACKGROUND

In some cases, it is useful for a user equipment (UE) to support connection to different communication networks, such as networks associated with different network carriers, different communication bands, different network capabilities, different network subscription characteristics, and the like, or any combination thereof. For example, in some cases a user can employ different network carriers for personal and business use. In these cases, it is useful for the UE to support connection to both the networks of the different network carriers. To allow for connection to the different communication networks, a UE can employ multiple Subscriber Identity Modules (SIMs), with each SIM providing the data and functionality for connection to a different network. However, existing techniques for network scanning at UEs having multiple SIMs have limited flexibility and can consume a relatively high amount of system resources.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a communication network including a user equipment (UE) that supports scanning for a plurality of networks in sequential fashion using multiple SIMs in accordance with some embodiments.

FIG. 2 is a block diagram illustrating aspects of the UE of FIG. 1 that support scanning for networks using multiple SIMs in accordance with some embodiments.

FIGS. 3 and 4 are signal flow diagrams illustrating an example of the UE of FIG. 1 scanning for a plurality of networks in sequential fashion using multiple SIMs in accordance with some embodiments.

FIG. 5 is a flow diagram illustrating a method of scanning for a plurality of networks using multiple SIMs in accordance with some embodiments.

FIG. 6 is a flow diagram illustrating a method of scanning for a plurality of networks with overlapping communication bands in accordance with some embodiments.

### DETAILED DESCRIPTION

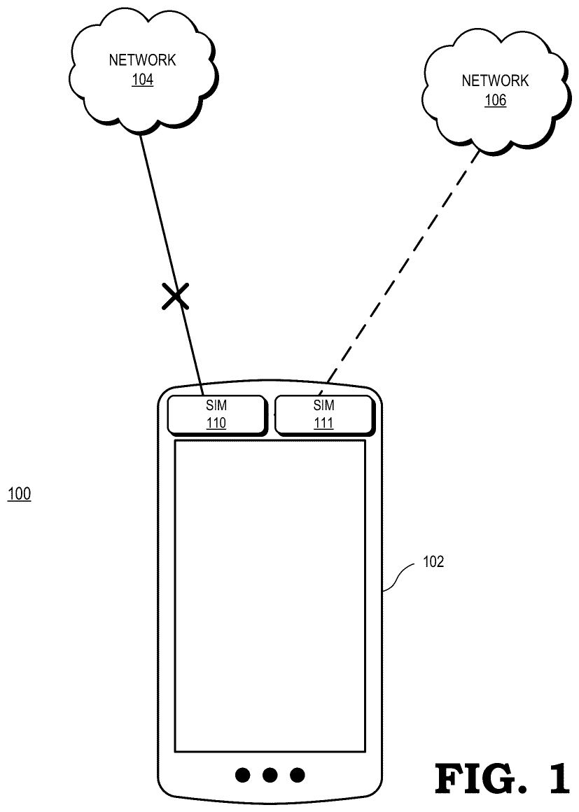

FIGS. 1-6 describe techniques for network scanning at a UE having multiple SIMs, wherein the UE scans for network connections using each of the multiple SIMs in sequence, until either a network connection is found, or the UE determines that there is no available network connection. Each of the multiple SIMs supports connection to a different network. In response to a primary SIM of the UE identifying an out-of-service (OOS) condition for the corresponding network, the UE sequentially employs a different one of the multiple SIMs to attempt to connect to a different network. This increases the likelihood that the UE is able to connect to a network, thereby improving the overall user experience.

To illustrate, when a conventional UE experiences an OOS condition with its primary SIM, the UE modem typically enters a status report condition, wherein the UE modem periodically sends status reports to each SIM, indicating the OOS condition. That is, the OOS condition is indicated to each SIM, including the SIMs that may have a network condition available. Because of the indication of the OOS condition, none of the SIMS attempt a network connection, limiting the overall connectivity of the UE. In contrast, using the techniques described herein, a UE is able to use each SIM to connect to a network, even when the primary SIM indicates an OOS condition. This extends the overall connectivity of the UE, and thus improves the user experience.

To further illustrate via an example, in some embodiments a UE includes both a physically removable SIM (pSIM) and two different embedded SIMs (eSIMs), designated eSIM1 and eSIM2. One of the embedded SIMs (eSIM1), supports connection to a first network, designated NCC and associated with a private carrier, and the other eSIM (eSIM2) supports connection to a second, different network, associated with the Citizens Band Radio Service (CBRS). The UE requests the modem PHY layer or radio frequency (RF) layer (referred to collectively as L1/RF) to scan a specified network band to attempt to connect to the NCC network using eSIM1. In response, for purposes of the example, the L1/RF indicates that no signal is available for the NCC network. Conventionally, this would result in eSIM2 reporting no available service. However, using the techniques described herein, responsive to no signal for the NCC network being available, the UE requests the L1/RF to scan the CBRS network band, using eSIM2, to attempt to connect to the CBRS network. If a CBRS network signal is available, the UE connects to the CBRS network. In some embodiments, the UE can include more than two SIMs (e.g., three eSIMs or more), and can continue the scanning process for each SIM and corresponding network until a connection is identified or until all SIMs and networks have been scanned. Thus, the connectivity of the UE is improved.

Further, as the UE scans each network, the UE can update a list of previously-scanned bands, and only scan those bands that are not on the list, so that for each network scan the UE only scans the bands and channel numbers that have not been previously scanned. To illustrate, in some cases the different networks associated with the UE have overlapping network bands and overlapping channel numbers (referred to collectively as the bands/CNs). Accordingly, in some embodiments, after a first network indicates an OOS condition, the UE scans for a second network by only scanning the bands/CNs for the second network that have not already been scanned for the first network. For example, after the L1/RF indicates no signal found for the first network, the UE determines the difference in the bands/CN for the first network and the second network, as indicated by eSIM1 and eSIM2, respectively. The bands/CN of the second network that have not been scanned are referred to as the “delta band/CN”. Responsive to the L1/RF indicating no signal found for the first network, UE Stack 2 requests the L1/RF to scan the delta band/CN to attempt to connect to the second network. Thus, the L1/RF does not attempt to rescan network bands or channel numbers that were already scanned (and for which no connection was found), thereby conserving UE resources, such as power.

FIG. 1 illustrates a communication network 100 implementing sequential scanning for network connections using multiple SIMs in accordance with some embodiments. As shown in FIG. 1, the communication network 100 includes a user equipment (UE) 102 that is capable of connecting to one or more networks (e.g., networks 104 and 106) via corresponding wireless network connections. The UE 102 can include any of a variety of electronic wireless communication devices, such as a cellular phone, a cellular-enabled tablet computer or cellular-enabled notebook computer, an automobile or other vehicle employing cellular services (e.g., for navigation, provision of entertainment services, in-vehicle mobile hotspots, etc.), and the like.

The networks 104 and 106 are networks that support communication of data, such as a packet data network (PDN), a telephone network, and the like (or a combination thereof). In some embodiments, the networks 104 and 106 have different network characteristics, such as being associated with different network carriers, having different communication bands, having different network capabilities, having different network subscription characteristics, having different radio access technologies (RATs), and the like, or any combination thereof. For example, in some embodiments the network 104 is owned or operated by one network carrier (e.g., a wireless network carrier) and the network 106 is owned or operated by a different network carrier. In some embodiments, the network 104 has different communication bands than the network 106 (that is, the UE connects to the network 104 using signals in a different frequency band than the signals the UE uses to connect to the network 106). Furthermore, in some embodiments the communication bands for the networks 104 and 106 are different, but the communication bands share at least one frequency in common (that is, the communication bands for the networks 104 and 106 overlap).

To support connection to the networks 104 and 106, the UE 102 includes multiple Subscriber Identity Modules (SIMs), including SIMs 110 and 111. The SIMs 110 and 111 are physical devices, software data structures, or a combination thereof that store data used to connect to a corresponding network. For example, in some embodiments the SIMS 110 and 111 each store an international mobile subscriber identity (IMSI) number and corresponding security information that the UE 102 provides to a corresponding network in order to authenticate the UE 102 and allow the UE 102 to connect to the network. In different embodiments, the SIMS 110 and 111 are any of a variety of SIM types, such as a removable storage device (e.g., a smart card), an embedded SIM (eSIM) that is embedded within the UE 102 (e.g., a device soldered to a circuit board of the UE 102), an integrated SIM (iSIM) that is integrated with a processor of the UE 102, and the like. Furthermore, in some embodiments the SIMS 110 and 111 are of different types. For example, in some embodiments the SIM 110 is a removable storage device, and is referred to as a pSIM, and the SIM 111 is an eSIM. It will be appreciated that in some embodiments the UE 102 includes additional SIMs not illustrated at FIG. 1, such as additional eSIMs or iSIMs.

As noted above, each of the SIMS 110 and 111 stores information the UE 102 uses to connect to a corresponding network. For purposes of description, it is assumed that the UE 102 uses the SIM 110 (that is, uses the information stored at the SIM 110) to connect to the network 104, and uses the SIM 111 (that is, uses the information stored at the SIM 111) to connect to the network 106. To connect to a network, the UE 102 employs a sequential scanning process, wherein the UE scans for each network for which the UE includes a corresponding SIM in a specified order, using the corresponding SIM, until an available network is located.

To illustrate, in some embodiments the UE 102 periodically encounters a network scanning condition, where the UE 102 scans for available networks. Examples of a network scanning condition include the UE 102 being powered on, the UE 102 entering or exiting a sleep mode, the UE 102 being disconnected from a Wi-Fi network, and the like. In response to entering the network scanning condition, the UE 102 uses a modem (not shown at FIG. 1) to scan for the network 104, using the SIM 110. In response to identifying that the network 104 is available (e.g., when the UE 102 detects a signal from the network 104 having sufficient strength and in response to successfully negotiating a communication session with the network 104), the UE 102 uses the SIM 110 to connect to the network 104. In response to the network 104 being unavailable (that is, the UE 102 determines that it is unable to connect to the network 104), the UE 102 proceeds to scan for the network 106, using the SIM 111. In response to identifying that the network 106 is available, the UE 102 connects to the network 106. Thus, the UE 102 scans for the networks 104 and 106 in sequential fashion (first scanning for the network 104, followed by the network 106), using the corresponding SIMs, until the UE 102 finds an available network. The UE 102 is thus more likely to connect to a network, improving the overall user experience.

In some embodiments, the networks 104 and 106 are associated with overlapping communication bands, such that the networks 104 and 106 share at least one signal frequency or downlink (DL) for signals used to connect to the corresponding network. Further, during the scanning process for a network, the UE determines the network signal strength for each frequency or DL in the network's communication band. Accordingly, to conserve power and other system resources, in some embodiments the UE 102 maintains, during the sequential scanning process, a list of signal frequencies and downlinks that the UE 102 has determined are unavailable (that is, a network connection is not available via those signal frequencies and DLs). When scanning for a network connection, the UE 102 only uses those frequency bands and DLs that are not on the list. In other words, if the UE 102 determines that a network connection is not available for the network 104 at a given frequency band or DL, when scanning for the network 106 the UE 102 omits the given frequency band or DL from the scanning process, thus conserving system resources.

To illustrate via an example, in some embodiments the UE can connect to the network 104 using bands 2, 4, 5, and 25, and can connect to the network 106 using bands 2, 4, 5, and 12. The UE 102 first attempts to connect to the network 104 using bands 2, 4, 5, and 25. In response to an indication from the UE modem that no connection is available, the UE 102 scans for the network 106 by scanning only band 12, thereby preventing duplicate scanning of bands 2, 4, and 5.

As another example, in some embodiments the UE 102 can connect to the network 104 using downlink (DL) 2112.5-2167.5 (EARFCN 25-575) and can connect to the network 106 using DL 2110.7-2154.3 (EARFCN 1957-2393). The UE 102 first attempts to connect to the network 104 using DL 2112.5-2167.5. In response to an indication from the UE modem that no connection is available, the UE 102 scans for the network 106 by scanning only DL 2110.7-2112.5, thereby preventing duplicate scanning of DL 2112.5-2154.3 and thus conserving resources of the UE 102.

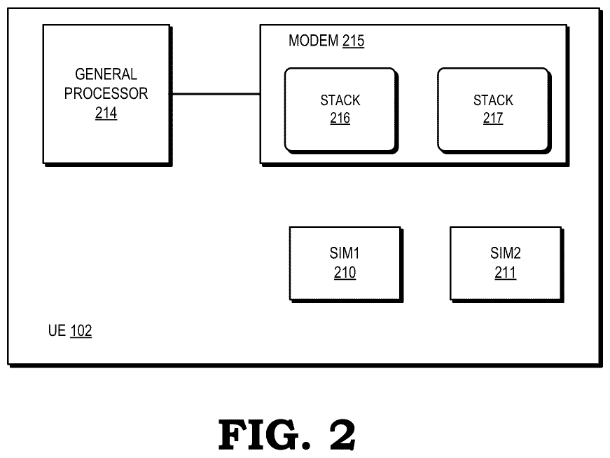

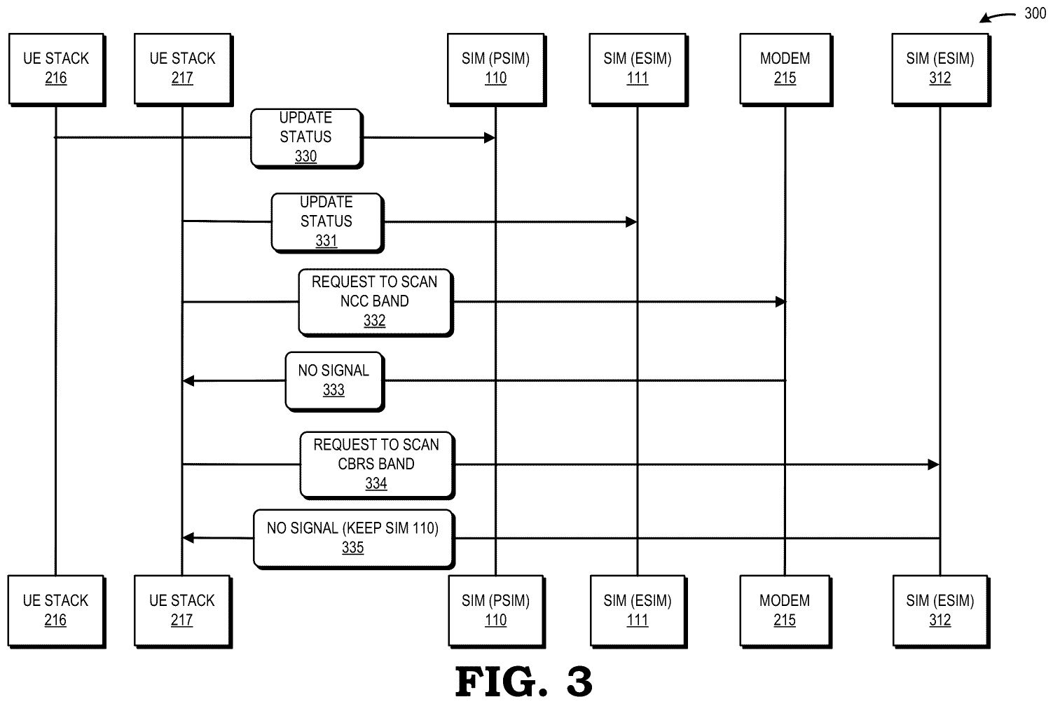

FIG. 2 illustrates an example hardware configuration for the UE 102 in support of sequentially scanning for available network connections in accordance with some embodiments. In the depicted example, the UE 102 includes a central processing unit (CPU) or other general processor 214, an RF modem 215, and the SIMS 110 and 111. In some embodiments, the UE 102 includes additional circuitry to support wireless network connections, such as a Wi-Fi transceiver and modem, at least one Wi-Fi antenna suitable for RF signaling and signal processing in one or more frequency bands typically associated with Wi-Fi connections, an RF transceiver, and at least one RF antenna suitable for RF signaling and signal processing in frequency bands associated with cellular RATs. Further, it will be appreciated that the UE 102 can include a number of additional components omitted from FIG. 3 for ease of illustration, including, for example, one or more displays, one or more touchscreens, keypads, mice, touchpads, microphones, speakers, and other user input/output devices, one or more sensors, batteries or other power sources, graphical processing units (GPUs) or other coprocessors, memory to store data on behalf of the processor 214, and the like.

As a general operational overview, the general processor 214 executes executable instructions from a software stack that includes an operating system (OS) and one or more user software applications and which further can include the protocol stacks executed by processors of the RF modem 215, including stack 216 and 217. In some embodiments, the RF modem 215 uses different stacks for each of the SIMs 110 and 111. For example, in some embodiments the RF modem 215 employs stack 216 when using the SIM 110 and stack 217 when using the SIM 111.

The OS manages the general operation of the various hardware components of the UE 102 as well as supports the execution of the one or more user software applications, with the user software applications typically accessed from system memory 304 for execution by the general processor 302. During execution, one or more processes of the OS or the user software application (referred to generally as “local processes”) may seek to wirelessly communicate data with a network connected to the UE 102, such as the network 104 or the network 106.

In the event that a local process is seeking to communicate data with a network (e.g., the network 106 or network 106), the general processor 302 can employ a cellular RAT connection, communicating data via the RF modem 215. For either of these connections the corresponding modem can handle lower-level operations associated with the corresponding network protocol, such as some or all of the physical, data link, and network layers, while the OS and the user software application executing at the general processor 302 support the higher-level layers of the network protocol, such as the transport, session, presentation, and application layers.

In some embodiments, the operating system executing at the general processor 214, upon detecting a network scanning condition, manages a sequential scanning process for available networks. The operating system first selects a network associated with a specified SIM, referred to as the primary SIM (e.g., SIM 110). The operating system instructs the modem 215 to scan for the network using information from the primary SIM. In response to detecting that the network is available, the operating system establishes, via the modem 215 a connection to the network. In response to determining that the network is not available, the operating system instructs the modem 215 to scan for a different network, using information from a different SIM (e.g., SIM 111). The operating system proceeds in this way to scan for a network until either 1) a network connection is established; or 2) the operating system has scanned using all SIMs of the UE 102.

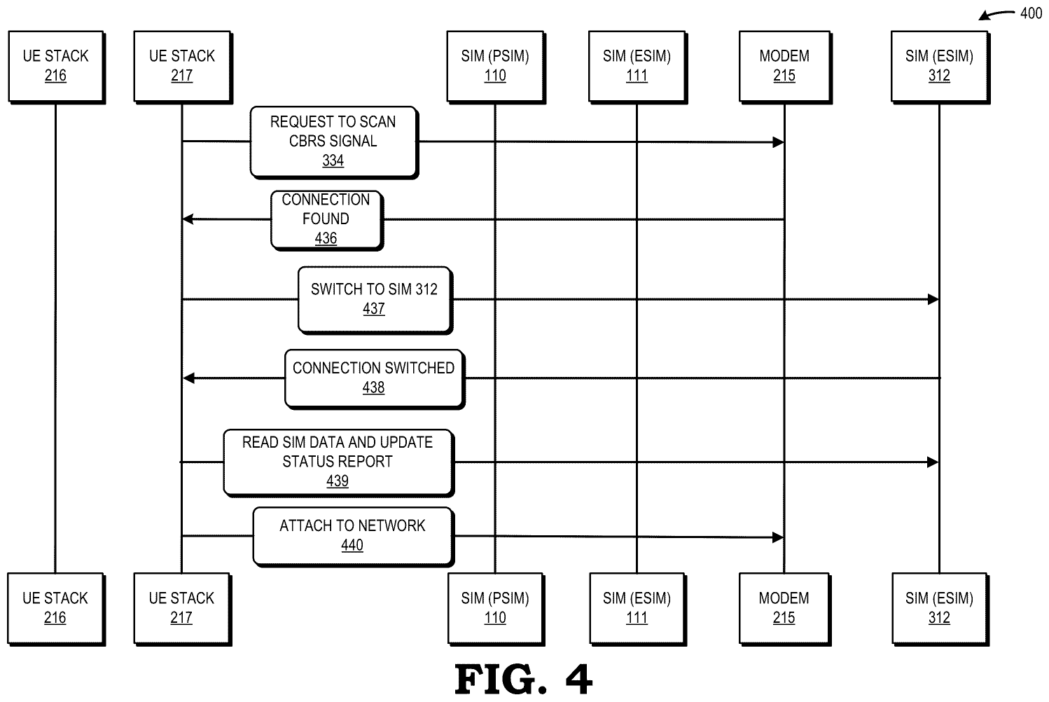

FIGS. 3 and 4 illustrate signal flow diagrams of an example of a sequential scanning process at the UE 102 in accordance with some embodiments. For the examples of FIG. 3, it is assumed that the UE 102 includes three SIMs, SIM 110 (the primary SIM), SIM 111 (an eSIM), and a SIM 312 (an eSIM). Each SIM stores information to support connection of the UE 102 to a different network. In addition, it is assumed that the RF modem 215 employs stack 216 for connecting to the network associated with SIM 110 and employs stack 217 for connecting to the networks associated with SIMs 111 and 312.

FIG. 3 illustrates the sequential scanning process 300 when neither the network 104 nor the network 106 are available in accordance with some embodiments. At block 330, the stack 216 sends an update status report for the SIM 110, indicating that the UE 102 is OOS with respect to the corresponding network (that is, the RF modem 215 has scanned for the network and the network is not available for connection). In response, the RF modem 215 switches to stack 217 and, at block 331, stack 217 sends an update status report message to trigger a scan for SIM 111 (that is, a scan for the network associated with SIM 111). Conventionally, the status report message at block 331 would result in the RF modem 215 determining the OOS status associated with the SIM 110, and in response entering a sleep mode. However, under method 300, the method flow proceeds to block 332 and the stack 217 requests the RF modem 215 to scan for the NCC network (the network associated with SIM 211).

At block 333, the RF modem 215 determines that no signal is available for the network and indicates this condition to the stack 217. In response, at block 334, the stack 217 requests the RF modem to scan for the network associated with the SIM 312 (in this example, the CBRS network). At block 335, the RF modem 215 determines that no signal is available for the network and indicates this condition to the stack 217. In response, the stack 217 maintains the SIM 210 as the primary SIM to be used for the initial scan the next time the UE 102 scans for available networks. Thus, in the example of method 300, the UE 102 sequentially scans for each the three networks for which the UE 102 has a corresponding SIM, increasing the likelihood of finding a network connection.

FIG. 4 illustrates a portion of a sequential scanning method 400, under a condition when the network associated with the SIM 312 is available, in accordance with some embodiments. It is assumed that the method 400 initially proceeds similarly to blocks 330-334 as described with respect to method 300 of FIG. 3. However, for the method 400, in response scanning for a CBRS signal at block 334, the RF modem 215 identifies a connection, and indicates the identified connection to the stack 217 at block 436. In response, at block 437, the stack 217 indicates a switch to the SIM 312, so that the information stored at the SIM 312 can be provided to the corresponding network in order to establish a network connection.

At block 438, the processor 214 indicates that connections have been switched to the SIM 312 (that is, the SIM 312 is indicated as the active SIM to be used for network connections). At block 439, the stack 217 reads the SIM data from the active SIM (the SIM 312) and sends an update status report message. At block 440, the stack 217 uses the SIM data read at block 439 to establish a connection to the CBRS network.

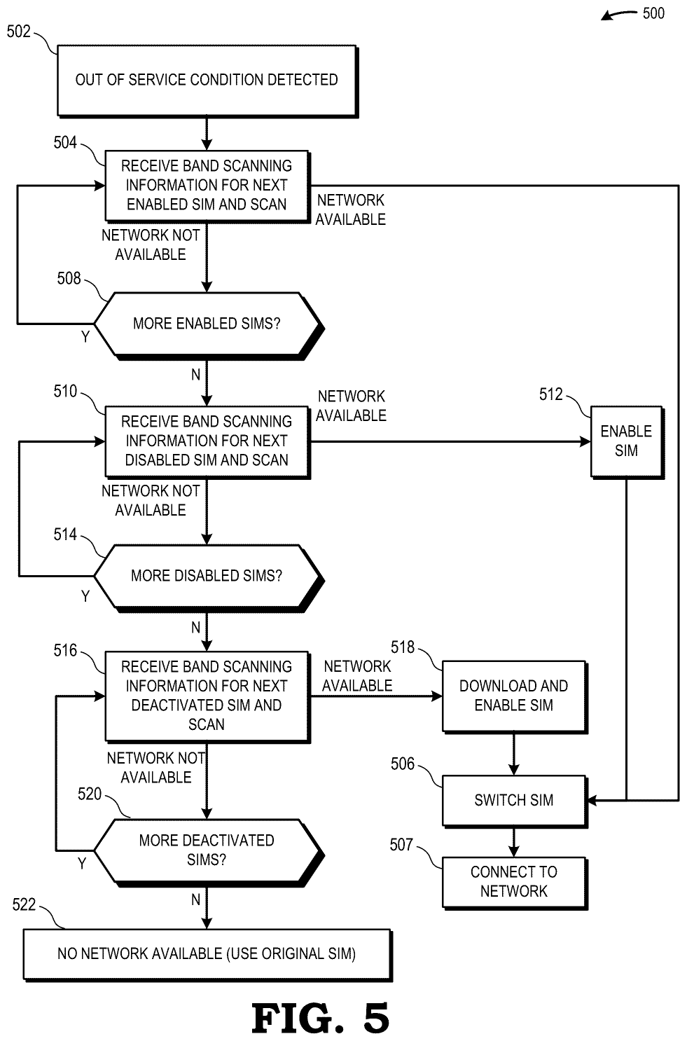

FIG. 5 illustrates a flow diagram of a method 500 of illustrating a method of scanning for a plurality of networks using multiple SIMs in accordance with some embodiments. For purposes of description, the method 500 is described with respect to an example implementation at the UE 102 of FIG. 1 and FIG. 2, but it will be appreciated that in other embodiments the method 500 is implemented at a UE having a different configuration. In addition, in order to conserve system resources it is assumed that the UE 102 has access to three different types of SIMs: 1) enabled SIMs (SIMs with information currently stored at the UE 102 and are in an accessible mode, such as an active power mode); 2) disabled SIMs (SIMs with information currently stored at the UE 102, but that are not in an accessible mode, such as SIMs in a low-power mode); and 3) deactivated SIMs (SIMs with information not currently stored at the UE 102, but that are available for download (e.g., via a Wi-Fi connection) to the UE 102.

At block 502, the processor 214 of the UE 102 detects a specified set of conditions for network scanning. For example, in some embodiments, the processor 214 determines that the UE 102 is in an OOS condition, determines that the UE 102 is to enter a sleep mode, or determines that there is no voice over Wi-Fi (Vowifi) connection currently available (either because Wi-Fi is not enabled or because Vowifi itself is not enabled at the UE 102). In some embodiments the UE 102 initiates scanning in response to one of these conditions, while in other embodiments the UE 102 initiates scanning in response to detecting a combination of these conditions.

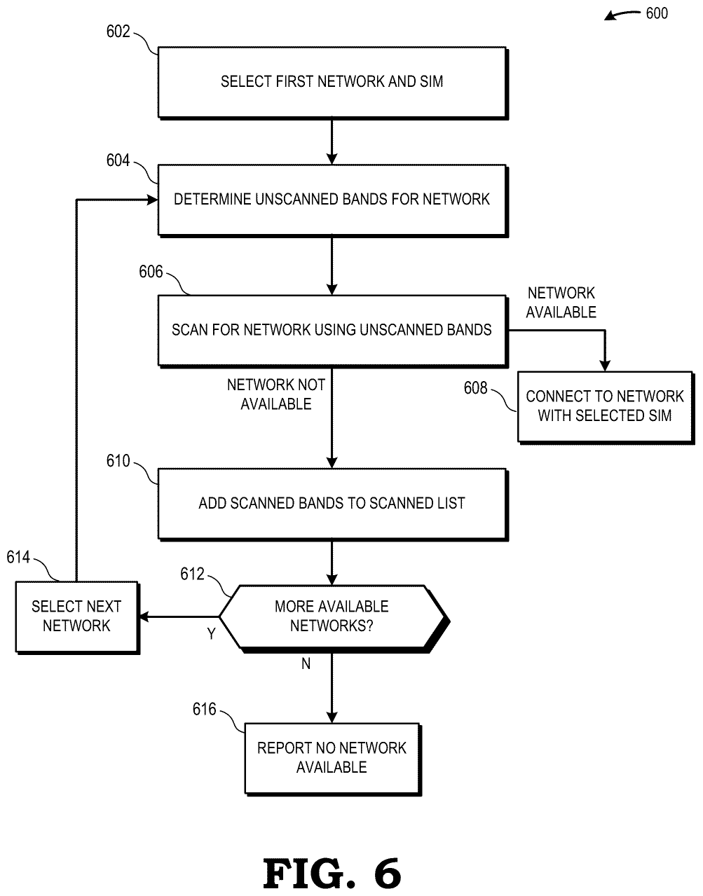

At block 504, the modem 215 selects an initial network for scanning. In some embodiments, the UE 102 stores an ordered list of networks (referred to herein as a network list) for which the UE 102 includes corresponding SIMs, and the modem 215 selects the initial network on the ordered list. The modem 215 identifies band scanning information for the selected network. For example, in some embodiments the selected network is associated with a set of specified communication bands, and the UE 102 stores, for each network in the network list, the corresponding set of communication bands, and selects for scanning the bands corresponding to the currently selected network. Furthermore, in some embodiments the UE 102 removes from the set of communication bands any bands that have been previously scanned in the current scanning process, as described further below with respect to FIG. 6. By removing previously scanned communication bands, the UE 102 conserves power and other system resources.

After determining the bands to be scanned for the selected network, the modem 215 initiates scanning for the determined communication bands. Based on the scanning, the modem 215 determines if the selected network is available. That is, the modem 215 determines whether there is an available connection for the UE 102 for the currently selected network. If so, the method flow moves to block 506 and the processor 214 switches to the SIM for the currently selected network. At block 507, the modem 215 uses the information stored by the selected SIM to connect to the selected network.

Returning to block 504, if the modem 215 determines the selected network is not available, the method flow moves to block 508 and the modem 215 determines if there are any more enabled SIMs for the UE 102. If so, the method flow returns to block 504 and the modem 215 selects the next enabled SIM (that is, selects the next network associated with an enabled SIM) from the network list for scanning. If, at block 508, the modem 215 determines that all the networks associated with enabled SIMs have been scanned, the method flow moves to block 510 and the modem 215 selects the first disabled SIM from the network list, and scans for the selected network. If the selected network is available, the method flow moves to block 512 and the processor 214 enables the corresponding SIM (e.g., by causing the SIM to exit a low-power mode). The method flow proceeds to block 506, where the processor 214 switches to the now-enabled SIM. At block 507, the modem 215 uses the information stored by the selected SIM to connect to the selected network.

Returning to block 516, if the modem 215 determines the selected network is not available, the method flow moves to block 520 and the modem 215 determines if there are any more networks in the network list associated with a deactivated SIM. If so, the method returns to block 516 and the modem 215 selects the next network associated with a deactivated SIM. If, at block 514, the modem 215 determines there are no more networks in the network list associated with a deactivated SIM, the method flow moves to block 522 and the modem 215 indicates to the processor 214 that there are currently no available networks for the UE 102.

FIG. 6 is a flow diagram of a method 600 of scanning for a plurality of networks with overlapping communication bands in accordance with some embodiments. For purposes of description, the method 600 is described with respect to an example implementation at the UE 102 of FIG. 1 and FIG. 2, but it will be appreciated that in other embodiments the method 500 is implemented at a UE having a different configuration. At block 602, the modem 215 selects a first network from the network list and selects the corresponding SIM. At block 604, the modem 215 determines the bands to scan for the selected network. In some embodiments, for each scanning session, the modem 215 maintains a list, referred to as a scanned list, of communication bands that have already been scanned during the scanning session. To determine the bands for scanning, the modem 215 first determines an initial set of bands based on a list of bands corresponding to the selected network (e.g., a set of bands indicated by a specification associated with the network), and then removes from the initial set any bands that have previously been scanned, as indicated by the scanned list. The modem 215 thus generates a list of unscanned bands for the currently selected network. This list is referred to herein as the unscanned list.

At block 606, the modem 215 scans the bands indicated by the unscanned list. If one of the bands indicates an available network connection, the method flow moves to block 608 and the modem 215 connects to the selected network using the information stored by the corresponding SIM. If, at block 608, the modem 215 determines there are no available connections via the scanned bands, the method flow moves to block 610 and the modem 215 adds the scanned bands to the scanned list, so that the bands are not scanned again during the current scanning session.

The method flow proceeds to block 612, and the modem 215 determines whether there are any additional networks on the network list for which at least one communication band has not been scanned during the current scanning session. If so, the method flow moves to block 614 and the modem 215 selects the next network from the network list for which at least one communication band has not been scanned during the current scanning session and selects the corresponding SIM. The method flow returns to block 604.

Returning to block 612, if the modem 215 determines there are no additional networks to be scanned (that is, all communication bands for all potential network connections have been scanned), the method flow moves to block 616 and the modem 215 indicates to the processor 214 that a network connection is not currently available. Thus, using the method 600, the UE 102 scans each communication band only once during each scanning session, even if one or more of the communication bands are associated with multiple scanned networks. The UE 102 is thereby able to scan for multiple networks while conserving power and other system resources.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skills in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method comprising:
determining an out-of-service (OOS) condition at a UE based on scanning for a first network associated with a first Subscriber Identity Module (SIM);
in response to determining the OOS condition, scanning, at the UE, for a second network associated with a second SIM; and
wherein scanning for the second network comprises scanning a subset of communication bands associated with the second network, the subset of communication bands omitting communication bands associated with the first network.

2. The method of claim 1, further comprising:
in response to determining a connection is not available for the second network, scanning, at the UE, for a third network associated with a third SIM.

3. The method of claim 1, wherein the second SIM comprises an embedded SIM.

4. The method of claim 1, wherein the second SIM comprises an integrated SIM.

5. The method claim 1, further comprising:
activating the second SIM from an inactive state in response to scanning for the second network.

6. The method of claim 1, further comprising:
downloading the second SIM to the UE in response to scanning for the second network.

7. A user equipment (UE) configured to execute the method of claim 1.

8. A system including a memory and a processor, the processor to execute instructions to perform the method of claim 1.

9. A user equipment comprising:
at least one processor;
a modem coupled to the processor;
a first Subscriber Identity Module (SIM) and a second SIM; and
at least one memory to store executable instructions configured to cause at least one or both of the at least one processor and the modem to:
determine an out-of-service (OOS) condition at the user equipment based on scanning for a first network associated with the first SIM; and
in response to determining the OOS condition, scan for a second network associated with the second SIM, including scanning a subset of communication bands associated with the second network, the subset of communication bands omitting communication bands associated with the first network.

10. The user equipment of claim 9, further comprising:
a third SIM; and
wherein the executable instructions are further configured to cause at least one or both of the at least one processor and the modem to: in response to determining a connection is not available for the second network, scan for a third network associated with a third SIM.

11. The user equipment of claim 9, wherein the second SIM comprises an embedded SIM.

12. The user equipment of claim 9, wherein the second SIM comprises an integrated SIM.

13. The user equipment of claim 9, wherein the executable instructions are further configured to cause at least one or both of the at least one processor and the modem to:
activate the second SIM from an inactive state in response to scanning for the second network.

14. The user equipment of claim 9, wherein the executable instructions are further configured to cause at least one or both of the at least one processor and the modem to:
download the second SIM to the user equipment in response to scanning for the second network.

15. A non-transitory computer readable medium storing executable instructions that, when executed, cause a user equipment (UE) to:
determine an out-of-service (OOS) condition at the UE based on scanning for a first network associated with a first Subscriber Identity Module (SIM); and
in response to determining the OOS condition, scan, at the UE, for a second network associated with a second SIM, including scanning a subset of communication bands associated with the second network, the subset of communication bands omitting communication bands associated with the first network.

16. The non-transitory computer readable medium of claim 15, wherein the executable instructions, when executed, further cause the UE to:
in response to determining a connection is not available for the second network, scan, at the UE, for a third network associated with a third SIM.

17. The non-transitory computer readable medium of claim 15, wherein the second SIM comprises an embedded SIM.

18. The non-transitory computer readable medium of claim 15, wherein the second SIM comprises an integrated SIM.

19. The non-transitory computer readable medium of claim 15, wherein the executable instructions, when executed, further cause the UE to:
activate the second SIM from an inactive state in response to scanning for the second network.

20. The non-transitory computer readable medium of claim 15, wherein the executable instructions, when executed, further cause the UE to:
download the second SIM to the UE in response to scanning for the second network.
